(19) United States
(12) Patent Application Publication
(10) Pub. No.: US 2005/0221674 A1
(43) Pub. Date: Oct. 6, 2005

(54) Power plug with overloaded display

(75) Inventor: Chan Ching, Taipei Hsien (TW)

Correspondence Address: TROXELL LAW OFFICE PLLC, SUITE 1404, 5205 LEESBURG PIKE, FALLS CHURCH, VA, 22041, US

(73) Assignee: Perfect Union Co., Ltd.

(21) Appl. No.: 10/815,815

(22) Filed: Apr. 2, 2004

(51) Int. Cl. H01R 13/66

(52) U.S. Cl. 439/620

(57) ABSTRACT

The present invention relates to providing a power plug with overloaded display, which provides users with the function of warning display for protecting the power plug from over-heated melting and from shorting and catching on fire. The character is that an embedded positioned block is arranged on the periphery of the electric metal-pin of said power plug, and a thermochromic film is coated on the surface of said embedded positioned block, and warning characters are printed on said embedded positioned block. The external body of said power plug is made by injection modeling with mixed transparent PVC and thermochromic materials, or the embedded positioned block may be directly injected with thermochromic materials, or connected with a detecting transistor linked by a light emitting diode (LED). When the power plug is over-heated and the temperature of the power plug gradually increases, the thermochromic materials or the LED will display a warning message.

### BACKGROUND OF THE INVENTION

Generally, electric equipment using alternating current usually is plugged into an alternating current plug by a power plug through wires. As we know, alternating current power source generally is divided into 2 types, 110 voltage and 220 voltage. At present, the most common structure applied for power plug comprises 2 or 3 electric metal-pins ( hot, neutral, and ground), wherein one end of the electric metal-pins is connected with the copper core of wires, after connecting, the back section of the electric metal-pins and a predetermined length of wire are molded or injection modeled with PVC to form an external body of the power plug, and the external body is suitable for being held by hand. The external body comprises a flexible rear fin, and enables the front section of the electric metal-pins exposed outside the power plug to contact the electric metal-sheet for conducting electricity, in this way, a power plug made of PVC is completed.

As we know, the electric metal-pin of a power plug generally is the easiest part to accumulate heat when using, especially the part between electric metal-pins and core of the wires usually is the key place for shorts and fires. If the equipment is overloaded, the temperature will increase.

Therefore, the PVC of the conventional used power plug, which contacts the electric metal-pins, will be hardened after a period time of using because of heat, resulting in the position changing between the two electric metal-pins or deforming the power plug. When in an abnormal overload condition and the temperature in electric metal-pins is increasing, if users do not shut down the power in time and check the equipment, which will melt the PVC and result in high temperature sparks. These conditions will make electric wires or equipment catch fire more easily, even resulting in fire accidents.

Then, if the conventional power plug can display a warning function when abnormal temperature increases, accidents will be avoided at an early stage.

### SUMMARY OF THE INVENTION

A power plug with overloaded display, which provides users with the function of warning display for protecting the power plug from over-heated melting, wherein an embedded positioned block is arranged on the periphery of the electric metal-pin of said power plug, and a thermochromic film is coated on the surface of said embedded positioned block, and warning characters are printed on said embedded positioned block. The external body of said power plug is made by injection modeling with mixed transparent PVC and thermochromic materials, or the embedded positioned block may be directly injected with thermochromic materials, or connected with a detecting transistor linked by a light emitting diode( LED). The appearance of the power plug is formed like a plug by being injected with transparent PVC. When the power plug is over-heated and the temperature of the power plug gradually increases, the thermochromic film will change its color to warn users or the LED will flash to protect the power plug from over-heated melting or from shorting and catching on fire.

### BRIEF DESCRIPTION OF THE DRAWINGS

FIG. 1 is a three-dimensional view showing the power plug with overloaded display of the present invention;

FIG. 2 is a three-dimensional view showing the power plug with overloaded display, which is made of thermochromic materials and printed with warning characters of the present invention;

FIG. 3 is a three-dimensional view showing the power plug made by injection modeling with mixed thermochromic materials and PVC;

FIG. 4 is the perspective view showing the power plug with overloaded display and arranged with a detecting transistor of the present invention;

FIG. 5 is the perspective view of FIG. 3 of the present invention; and

FIG. 6 is the cross-section view for another example of FIG. 3 of the present invention.

### DETAILED DESCRIPTION OF THE INVENTION

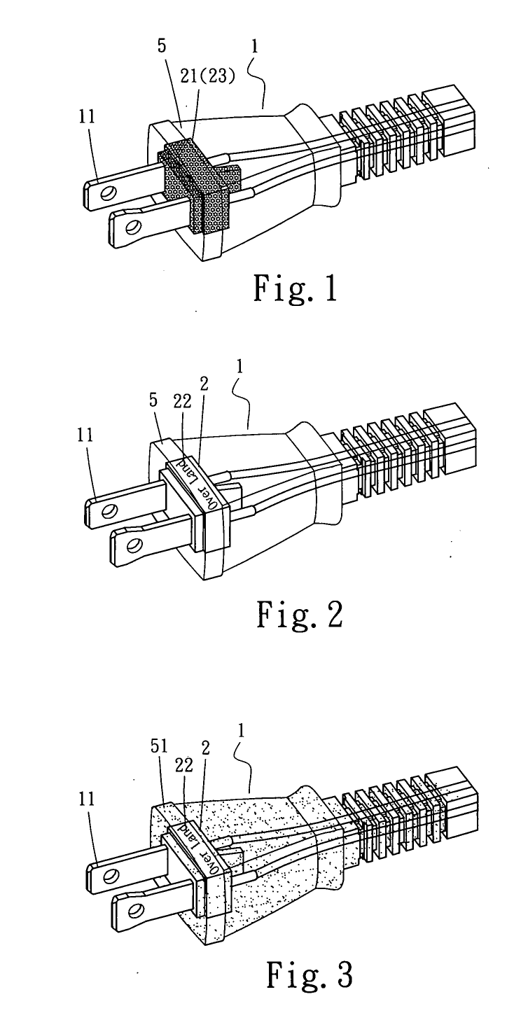

The power plug with overloaded display of the present invention is as shown in FIG. 1. The present invention relates to embedding an orientated block (2) on the periphery of the electric metal-pins (11) of a power plug (1), wherein the embedded positioned block (2) is made of fire-resistant, and high intensity materials insulated against electricity and heat, and arranged with positioned metal-pins (11), such as PBT ( Polybutylene Terephthalate) . . . etc. The embedded positioned block (2) may be coated with thermochromic film (21), or be formed by directly injected with thermochromic materials (23), and the appearance of the external body (5) of the power plug is formed like a plug by injection modeling with transparent PVC.

As above mentioned, when the power plug is overloaded and the temperature of it increases under use, users can be noted or warned that the power plug is under unusual temperature increasing condition by the color change of the thermochromic film (21), or by the color change of the embedded positioned block (23) containing thermochromic materials, for security control such as shutting down the power immediately . . . etc, which protects the power plug from over-heated melting or form shorting and catching on fire.

As shown in FIG. 2, the surface of the above mentioned embedded positioned block (2) may also be printed with warning characters (22) (such as overload, or danger) containing thermochromic materials, wherein the warning characters will change its color when the power plug is overloaded and its temperature increases. In this way, users also can be noted or warned that the power plug's temperature is unusually increasing.

As shown in FIG. 3, the external body (51) of the power plug of the present invention may also be injection modeled with mixed thermochromic materials and PVC to change its color to warn users when the power plug is overloaded and the temperature is increasing.

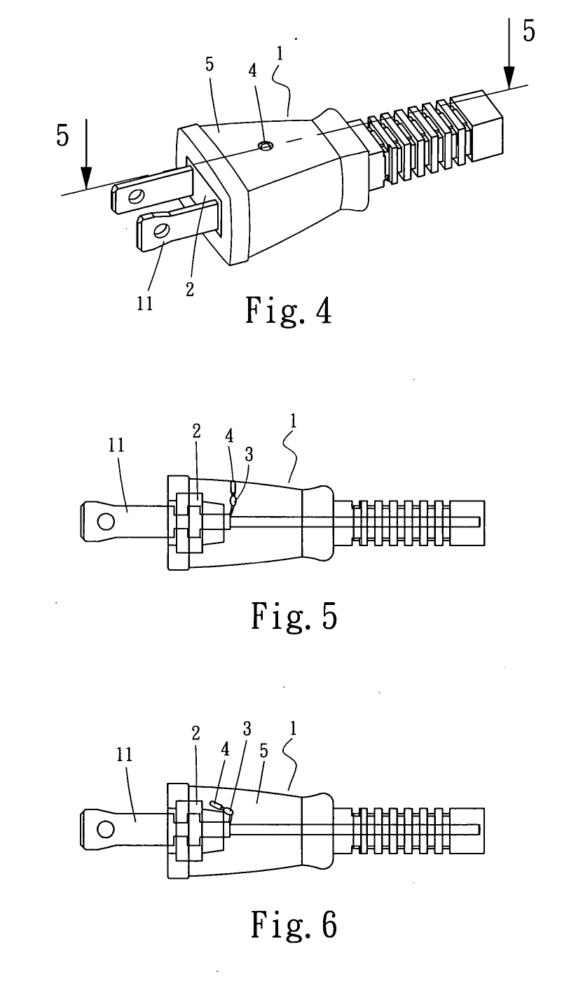

With the above mentioned methods for warning, as shown in FIG. 4 and FIG. 5, the present invention furthermore may comprise a detecting transistor (3) arranged on the power plug, and connect with a light emitting diode (LED, 4). The top of the LED is exposed outside the surface of the external body (5) of the power plug (which makes the materials for the injected external body (5) not only limited in transparent materials), or as shown in FIG. 6, the LED (4) is arranged with the external body (5) of the power plug injection modeled with transparent PVC materials. Hence, when the detecting transistor (3) detects that power plug (1) is overloaded, the LED (4) will be flashed to note or warn users that the temperature of the power plug is in abnormal increasing condition, to protect the power plug from over-heated melting or from shorting and catching on fire.

1. A power plug with overloaded display, comprising an embedded positioned block arranged on the periphery of the electric metal-pin of said power plug, wherein a thermochromic film is coated on the surface of said embedded positioned block, and the external body of said power plug is made by injection modeling with transparent PVC, therefore, users can be noted or warned that said power plug is under unusual temperature increasing condition by color change of the thermochromic film coated on said power plug, after said power plug is overloaded.

2. The power plug with overloaded display according to claim 1, wherein said embedded positioned block is printed with warning characters made of thermochromic materials.

3. The power plug with overloaded display according to claim 1, wherein said external body of said power plug made by injection modeling is injected by mixing the thermochromic materials with PVC.

4. The power plug with overloaded display according to claim 1, wherein said embedded positioned block is directly injection modeled with thermochromic materials.

5. The power plug with overloaded display according to claim 1, wherein the melting joint between said electric metal-pin and a power wire is extendedly connected with a detecting transistor and a light emitting diode (LED), and the top of said LED is exposed outside the surface of said electric plug, hence, when said detecting transistor detects that said power plug is overloaded, said LED will be flashed to note or warn users that the temperature of said power plug is abnormally increasing.

6. The power plug with overloaded display according to claim 4, wherein said LED connected with said detecting transistor is embedded into the external body of said power plug injected with transparent PVC.
